(19) United States
(12) Patent Application Publication
(10) Pub. No.: US 2013/0339886 A1
(43) Pub. Date: Dec. 19, 2013

(54) TOOLS FOR DYNAMIC DATABASE DRIVEN CATALOG BUILDING

(71) Applicant: Computer Pundits, Inc., Bloomington, MN (US)

(72) Inventors: Prashubh Batham, Prior Lake, MN (US); Jason A. Walberg, St. Louis Park, MN (US); Bradley J. Honsey, Bloomington, MN (US)

(21) Appl. No.: 13/920,837

(22) Filed: Jun. 18, 2013

Related U.S. Application Data
(60) Provisional application No. 61/661,136, filed on Jun. 18, 2012.

(51) Int. Cl. G06F 3/0481; G06F 3/0482

(52) U.S. Cl. CPC G06F 3/0481; G06F 3/0482
USPC 715/765

(57) ABSTRACT

To provide the efficient and effective presentation of product information, a system and method are utilized which are database driven and highly automated. Utilizing a appropriate coding in the database itself, product categories and subcategories are identified which can be thus utilized in the presentation and product information to potential customers. Further, the coding within the database include necessary indicators to produce menus and submenus without the need for separate links or URLs when generating in a database format. Further, utilities are provided to easily hand and manage images corresponding to the listed products themselves. This image management is efficiently carried out depending upon the necessary image size and use. Lastly, due to the database structures and related coding, content groups and modified product content information is easily generated as necessary.

### CLAIM OF PRIORITY

This application claims priority to U.S. Provisional Patent Application Ser. No. 61/661,136 filed Jun. 18, 2012 entitled “Tools for Dynamic Database Driven Catalog Building”, and is herein incorporated by reference in its entirety.

### BACKGROUND

A system and method for efficiently presenting up-to-date product information to potential consumers or purchasers provides a useful marketing and sales tool for any organization handling products. More specifically, the system and method provide a database driven methodology which effectively and efficiently allows organizations to present information related to products in an attractive and pleasing manner. Product information can thus easily be presented to potential customers and users in an online presentation format, in printed materials, or in a CD/DVD computer readable format, depending on the particular needs of a user.

Product manufacturers, distributors, sales representatives, retail establishments, etc., all have a desire to present product information to potential purchasers in an efficient and effective manner. In many cases, this product information can involve different features, specifications, options, or other variations. Due to the potential existence of many product variations and unique features, large amounts of data is typically maintained and used in product sale situations. In addition, the actual presentation of product information can take many forms including printed publications (i.e., catalogs), online catalogs or web displays, or special printing options. Aside from the actual format, the presentation of information in an effective, pleasing, and up-to-date manner is of utmost importance to all involved individuals.

In order to allow for appropriate purchasing decisions by their customers, sales related organizations typically maintain the above mentioned extensive databases related to their product offerings. These databases typically include a listing of the type of products, appropriate product categories, various features or options for each product, product images, and several detailed specifications. The ability to present this information in either a customized online or print format provides significant tools for sales and marketing personnel.

In many cases, the creation of customized webpages, online catalogs or print catalogs requires significant set-up and processing. For example, it is often necessary to reconfigure web pages when product offerings and/or product specifications change. Similarly, the layout and production of printed catalogs also requires modification when changes are necessary. Some methods do exist to automatically build these catalogs, however additional enhancements would be beneficial.

### SUMMARY

The present system and method to automatically create product presentation materials based on information contained within a company maintained database. The system itself is able to create both online product presentation, electronically stored product presentation (i.e. stored on CD's, DVD's, or storage devices) and printed materials. The system is particularly useful in the presentation of online information however, since it is continuously up-to-date and current. Stated differently, since the source of information used in product presentation purposes is the database itself, maintenance of this database also ensures the product presentation information is current and up-to-date. An additional benefit of the layout being driven by the database is that the presentation is easily adaptable without the necessity to redesign particular web pages. More specifically, the layout of information will dynamically change when information in the database has changed. This is particularly useful when new features are added to the database.

In addition to the advantages discussed above, the present system avoids the need for links within the various pages due to the fundamental differences in operation. A separate URL is not used to reach separate pages, thus, the process is much more efficient. Any “linked” commands simply cause an appropriate connection to the database and the creation of applicable layouts. The database itself contains all necessary information to complete these functions without the need for additional coding, etc. In addition, the system can handle many data types contained in the database, thus providing flexibility.

The system is also designed to easily handle multiple types of information in many different formats. In the preferred configuration, all information is stored in plain text format, but can be automatically converted as necessary. As one example, product information provided in plain text format, HTML messages or other formats is easily utilized converted to text format by the system prior to the storage step. When retrieving information for presentation (i.e. website, electronic catalog, printed materials, etc.), the system can then convert to HTML format after information has been retrieved. In this manner the product materials (printed or written) can be prepared regardless of the data type utilized for source data, or output format.

To provide further efficiency, the system and method effectively manages images for use in product presentations. The database itself maintains/stores a single image file, while additional mechanisms provide the ability to perform several conversions, thus increasing efficiency. As one example, a high resolution image may be stored/saved in the database for use whenever high resolution is necessary. This high resolution image will typically be used in print catalogs which can easily and efficiently utilize these types of images. The system also includes appropriate mechanisms to automatically convert to more efficient formats when used for other purposes, such as online product presentations. For example, a high resolution photograph may be converted to JPEG for an online presentation. JPEG file sizes are typically much more manageable, thus allowing the online product presentation to be more efficiently generated.

In addition to the data format of image files, the efficient management of these files is achieved through appropriate mechanisms and routines. More specifically, the system easily manages dynamic resizing and adjustment of images based upon need. In online product presentations, three typical image sizes are often utilized. These image sizes include the “thumbnail” “medium” and “large” sized images. Utilizing a single source of data, the present system automatically creates the appropriate sized image utilizing internal mechanisms and protocols.

To further illustrate the adaptability of the present data presentation system, any dropdown menus needed for an online presentation format are automatically created by simply utilizing information within the database itself. The categories and subcategories within the database will coordinate operations of the online presentation, thus allowing for dynamic drop down menu (or pop-up menu) creation. This avoids the need for coding to generate the dropdown menus. In addition, since these features are coming directly from the database, the information is continuously current and appropriate. Stated differently, the dropdown menus (or pop-up menus) will present information in a manner that is usable and up-to-date.

In addition, the system and methods of the various embodiments utilize filtering techniques to allow for the efficient handling of information. Again, these filters are data driven and based upon information contained in the database itself. As one example, the database maintains a listing of attribute filter parameters which can be applied globally to the database, and not to a subset, thus more efficiently providing the ability to focus in on certain products or groups of products. This attribute filtering itself is dynamic, thus following the data within the database. Again, this avoids the necessity to create separate filtering systems. In addition, other filtering techniques are used by the present system, which are further discussed below.

Each of the above features provides an advantageous system for coordinating product presentations in an up-to-date and current manner. By having these systems being database driven, efficient and productive product presentations can be easily created. Each of the characteristics and features summarized above cooperate with one another to provide a comprehensive system capable of managing sales and product information. With reference to the attached figures, additional details related to each of these characteristics is outlined below.

### BRIEF DESCRIPTION OF THE DRAWINGS

Further details of the disclosed embodiment will be better understood by consulting the following detailed description, in conjunction with the drawings in which:

FIG. 1 is a schematic system illustration showing one possible embodiment;

FIG. 2 is a general representation of the database structure;

FIG. 2A is a more detailed example embodiment of the database structure;

FIG. 3 is a flowchart of the presentation building process;

FIG. 4 is an example embodiment of the dropdown menu;

FIG. 5 is an illustration of the setup process for creating dropdown menus;

FIG. 6 is a schematic illustration of a potential webpage;

FIG. 7 is an alternative embodiment for a webpage presentation;

FIG. 8 is yet an alternative embodiment of the webpage presentation.

### DESCRIPTION OF THE PREFERRED EMBODIMENTS

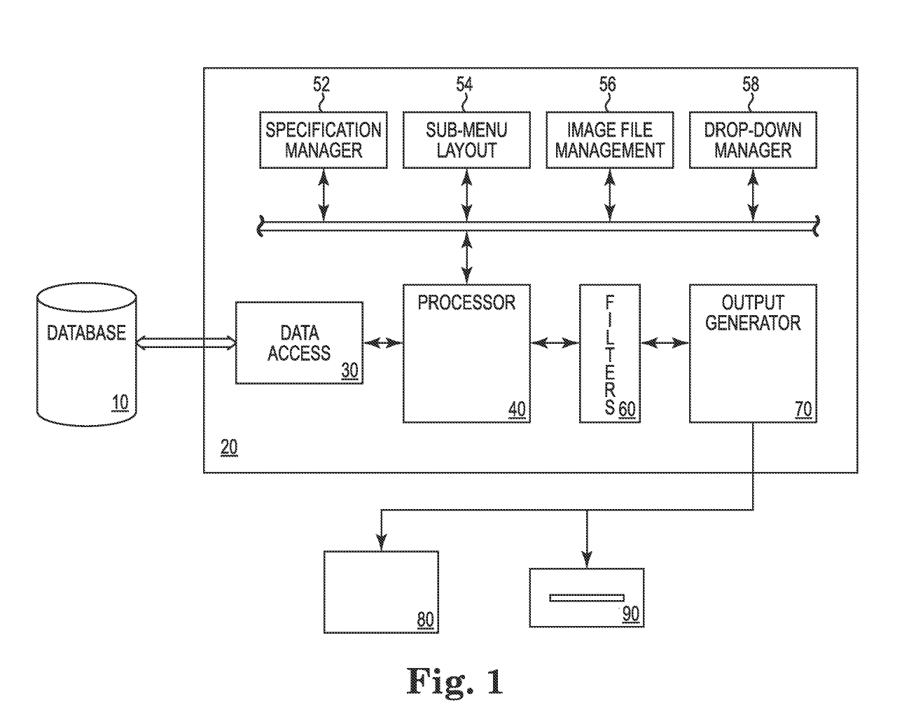

Generally speaking, the system and methods described herein are carried out on a computer system. As is well understood, this system can generally be implemented in any well known configuration including a single computer utilizing a single memory device, a network based configuration, or any combination thereof. One possible configuration is generally illustrated in FIG. 1. As shown, this system includes a database 10 which communicates with a processing system 20. The illustrated processing system 20 can include many components or subsystems.

Referring again to FIG. 1, one example of the various subsystems utilized by the present system are illustrated in a schematic format. As shown, processing system 20 (or computer system 20) communicates with database 10. To accommodate data communication, a data access manager 30 coordinates a majority of the data communication. A processor 40 carries out overall coordination of the systems, features and subsystems involved. Processor 40 communicates via a bus 50 to various subsystems including a specifications manager system 52, a submenu layout system 54, an image file management system 56, and a dropdown menu manager 58. Although these subsystems are illustrated in FIG. 1 as separate elements, it will be understood by those skilled in the art that separate hardware and/or processors are not necessary for each of these functions carried out by the systems and methods discussed herein.

Also, interacting with processor 40 is a filter system 60 which can be selectively applied depending on the request by the user. Ultimately, an output generator 70 will receive the filtered information in a manner appropriate for presentation to a user. This information could be presented via a monitor 80 or a printer 90 depending upon the format of information desired.

Outlined below are additional details regarding the various features referenced above. Although the particular features are illustrated and discussed separately, it will be understood that combinations of all of these are typically carried out simultaneously by the system.

I. Specifications Management

As generally discussed above, the disclosed system manages large amounts of information, including details, specifications, options and features for various products sold, manufactured, distributed or marketed by various organizations. For ease of description, these multiple options, features, details, etc. are generally referred to “attributes” in the discussion below. In the discussion below, a “specification” will refer to the detailed characteristics of a particular product (i.e. a product specification). The database itself will contain all of these attributes for a vast array of products, as necessary for a particular manufacturer/seller.

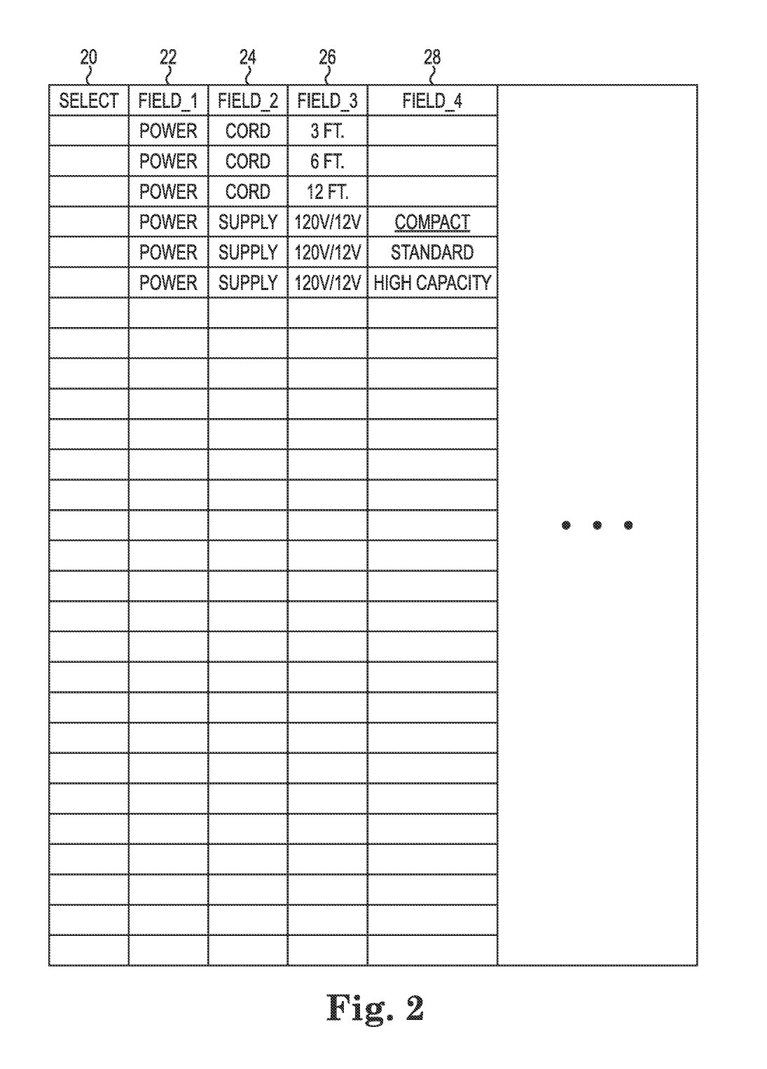

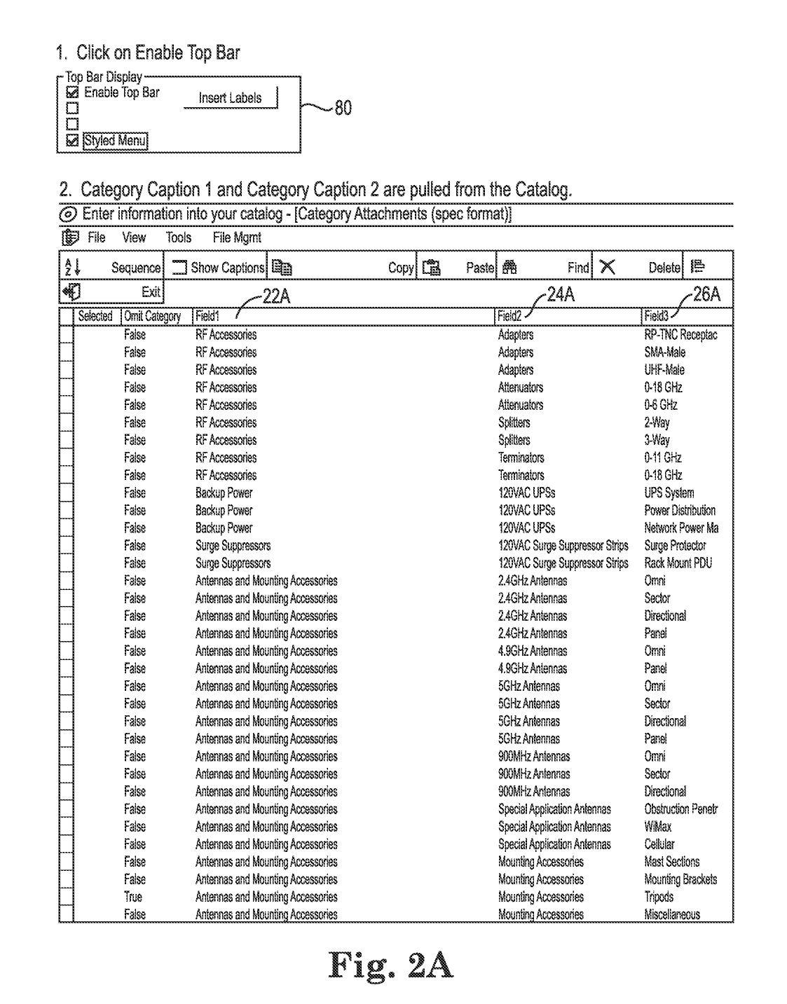

Referring now to FIG. 2, a graphic illustration of the user database configuration utilized by the present embodiment is shown. Although the information is illustrated here in a table format, this could be stored as a virtual table or nesting of various compound tables as well. In the database contemplated, the cells within the data table are utilized to contain attributes of various products. Generally speaking, each row within the table relates to a particular product. Various cells are utilized, depending upon the specific product information and the specific detail required. Since the various columns within the table are adaptable, the information contained therein is not specifically categorized or limited. In this example, generic column labels are thus utilized, thus allowing flexibility of the system. As shown in this example, the columns are simply identified with the headings. Select 20, Field_1 22, Field_2 24, Field_3 26, etc. To provide one example of the database, labels have been included in certain boxes in FIG. 2. In this particular example, the various products all relate to power components. Thus, field_1 22 simply includes the indicator “power.” Next, field_2 24 is used to further categorize the information. More specifically, the first three fields of field 2 24 are labeled “cord” while the last three are labeled “supply.” As further illustrated here, field_3 26 is thus utilized to further specify options or specifications for different product offerings. Field_3 26, in the first three cells, include various cord lengths such as “3 feet,” “6 feet,” and “12 feet.” With regard to the power supply components, field_3 26 is utilized to provide information related to a next level of category, in this case each including 120 volt/12 volt power supplies. In this case, such additional information is necessary. In this particular example, field_4 28 is thus utilized to indicate “compact,” “standard,” and “high capacity.” As illustrated by these various examples, the various nesting utilized by the database can thus continue on at multiple levels, utilizing a number of different fields as necessary.

Although not specifically illustrated in FIG. 2, additional types of information related to the particular products can be included in particular cells. As one specific example, various cells may be utilized to indicate the location where photographs or images are stored. In this manner, it is easy to correlate specific product information, photographs, etc.

II. Submenu Creation from Database

In many different situations, it is necessary for the information presentation system to create submenus of many different types. In certain applications, this may include the creation of dropdown menus in a website, the categorization of products for preparation of printed materials, etc. In order to accomplish this, the present system and method utilizes data structures existing in the database to extract category information, and format this information in the most appropriate configuration.

With reference to FIG. 2A, it can be seen how the appropriate submenu data structures may be easily extracted. FIG. 2A is essentially the same as FIG. 2, however this representation includes certain details related to attribute tools used by the system and method of the illustrated embodiment. The groupings of various attributes, and their correlation with one another allows the data structures (i.e. drop down menus or submenus) to be easily adapted without need for separate coding or processing. As one example, during the building of a website which presents desired information, when a particular product type or category is identified, the system can automatically identify the appropriate attributes for that product type itself. These attributes are then used to present to the user with appropriate and relevant submenus. Often, this involves dropdown submenus and related structures appropriate for this purpose, however pop-ups or attribute bars are also contemplated.

Looking more closely at FIG. 2A, provides one example of how Field 1 reference number 22A and Field_2 22A are utilized to create a submenu or dropdown menu. The system and method recognizes that various categories and various fields within the database can be utilized for categories or dropdown menus. In this regard, Field 1 22A is recognized and enabled, using selection block 80 to enable this functionality. When enabled, the system automatically recognizes the values in Field 1 22A to create a first level of some submenus. In this manner, the appropriate caption values can then be pulled from the listed values, to create categories. In a similar manner, the information in Field 2 24A is utilized to generate a second level of submenu. As further discussed below, this will also be utilized for generating dropdown menus.

Referring now again to FIG. 1, the submenu layout system 54 coordinates this submenu generation process. More specifically, the systems involved coordinate with the database structure to automatically generate submenu layouts where appropriate. These submenus are then provided to processor 40 during the presentation of information as necessary.

III. Image File Management

Generally speaking, image files are managed by the system in a database driven manner, wherein the database maintains the location of stored images related to certain products. In practice, only a single stored image is utilized, with the database containing the storage location. The system includes further processing steps to convert images where necessary. For example, where a high resolution image is necessary, the image file stored at the identified location will simply be utilized (if it is a high resolution image). However, if high resolution is not necessary or not efficient, the system will convert the image as necessary before presented along with product information. For example, where a website is illustrating photographs, it is unnecessary for high resolution images to utilize. Consequently, the efficiency and effectiveness of the system is encouraged by automatically converting or resizing the image as needed.

IV. Dropdown Menu Creation/Management

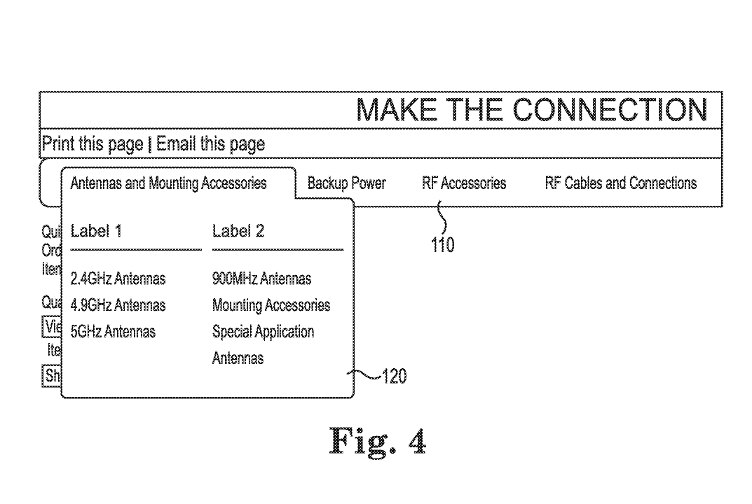

In a manner similar to the submenu creation discussed above. The menu manager 58 of the present system is also capable of dynamically creating appropriate dropdown menus. These dropdown menus are created entirely from the database itself, without the need for additional coding or special routines. The dropdown manager 58 recognizes the existence of appropriate values or items within the database and dynamically formats these as dropdown menus when needed. Because the dropdown menus are dynamically created by values within the database, the change or addition of information to the database itself will create additional selections for a dropdown menu. The results of this process are illustrated in FIG. 4. More specifically, FIG. 4 illustrates one potential rendering of a web page wherein a number of top bar menu items are listed at a top bar section 110. Each menu item will include a number of designated submenus which are presented as dropdown menus. In this particular case, a single dropdown menu 120 is shown. Dropdown menu 120 includes two columns of information, with each column including a label (identified in this example as label 1 and label 2) and a number of data items listed under each label. As will be further discussed below, each of these items are generated directly from the database.

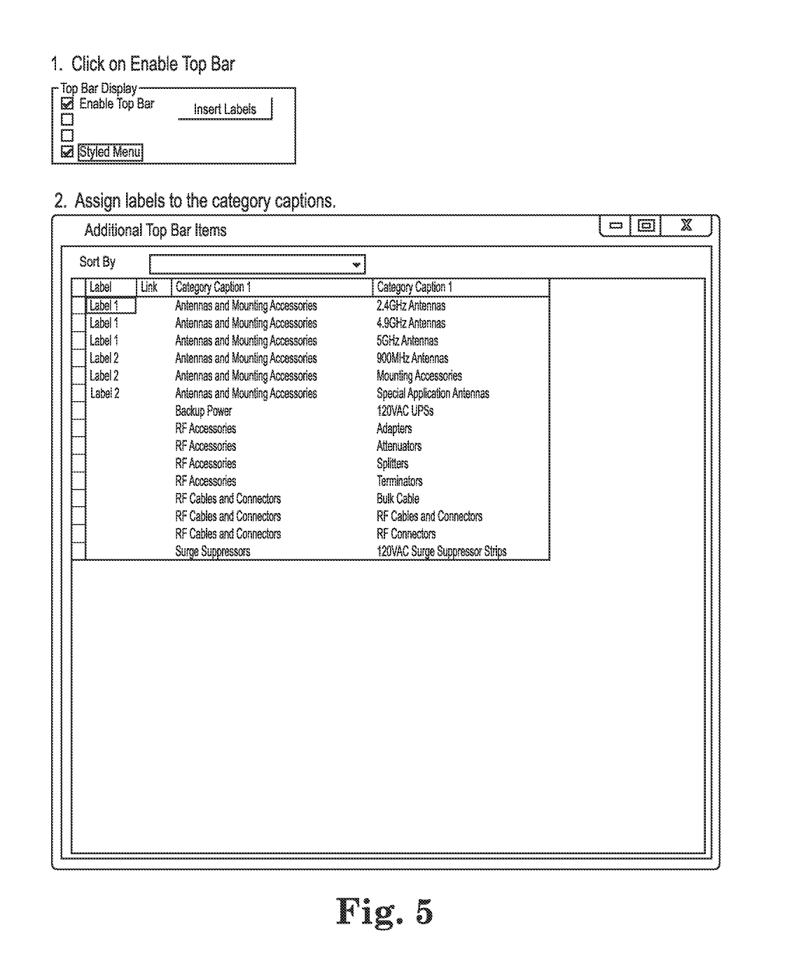

The generation of dropdown menus 120 is further illustrated with reference to FIG. 2A and FIG. 5, which illustrates a setup process for the configuration of top bar, side bar and dropdown menus. As shown in FIG. 2A, the first steps of building the top bar involves enabling and selecting category captions (headings) from the catalog (database). These captions will then be assigned to the top bar when the site is built, and will appear at the designated locations. Next, labels are assigned for the selected category captions using the attributes in the database which are common to a particular category. This label selection step is generally illustrated in FIG. 4, wherein various captions are associated with assigned labels. As shown, the top bar is enabled and subsequently labels (Label 1 & Label 2) are assigned to corresponding attributes contained in the database. Once the captions and labels are identified, the system will build the website structure utilizing this information. The category captions are listed across top bar 110 (as shown in FIG. 4) while each dropdown menu is dynamically configured utilizing the information identified by the appropriate labels. Since this information ties directly back to the database itself (see, e.g. FIG. 2A), all information will be dynamically adjusted whenever database changes are made. For example, the addition of a product model within an identified category will appear when the website is next built. Selection of the necessary category from the dropdown menu will thus be linked to appropriate sections within the database itself and further details related to the product listings can be easily provided.

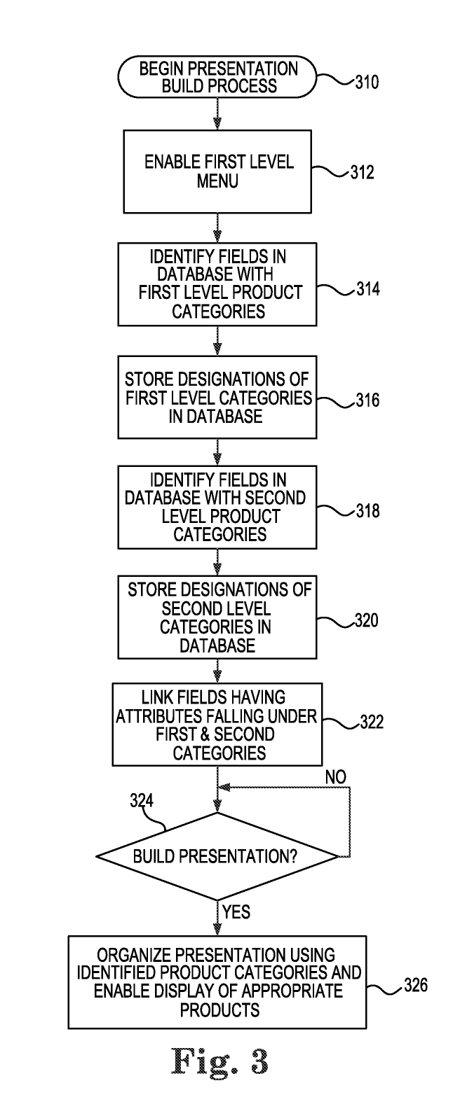

As suggested above, the present embodiment involves the database driven development of various presentation formats. One such format includes the creation of a website providing menu options appropriate for the product information within the database. FIG. 3 illustrates one example process for the creation of a menu driven presentation. As shown, the example process has a starting point (310) which is enabled by a user. Next, the process will enable a first level menu (312) and then identify those fields in the database having first level product categories (314). These designations are stored within the database (316) for further use in preparing product presentations. In a similar manner, fields with second level product categories are identified (318) and stored (320). Once all designations have been stored, links are established with all of the attributes falling under the first and second categories (322) so this information will be readily available when it becomes necessary to build presentations (i.e. catalogs, websites, etc.). At this point, the database contains the necessary identifiers and links, so that the presentations can be build at any point in time. When it is desired to build the presentation, the process will then organize the presentation using the identified categories and will enable the display/output of information for all products falling within the appropriate categories (326).

In the discussion above related to the top bar of a presented website, the system follows the general process of enabling certain features, designating appropriate information from the database, and subsequently building the appropriate pages as desired. While this is all dependent entirely upon information in the database, it does involve the system carrying out a build process to achieve the desired goals. With certain features of the website, however, the system and method contemplated do not require separate build processes and are consistently live or current based solely on the information within the database.

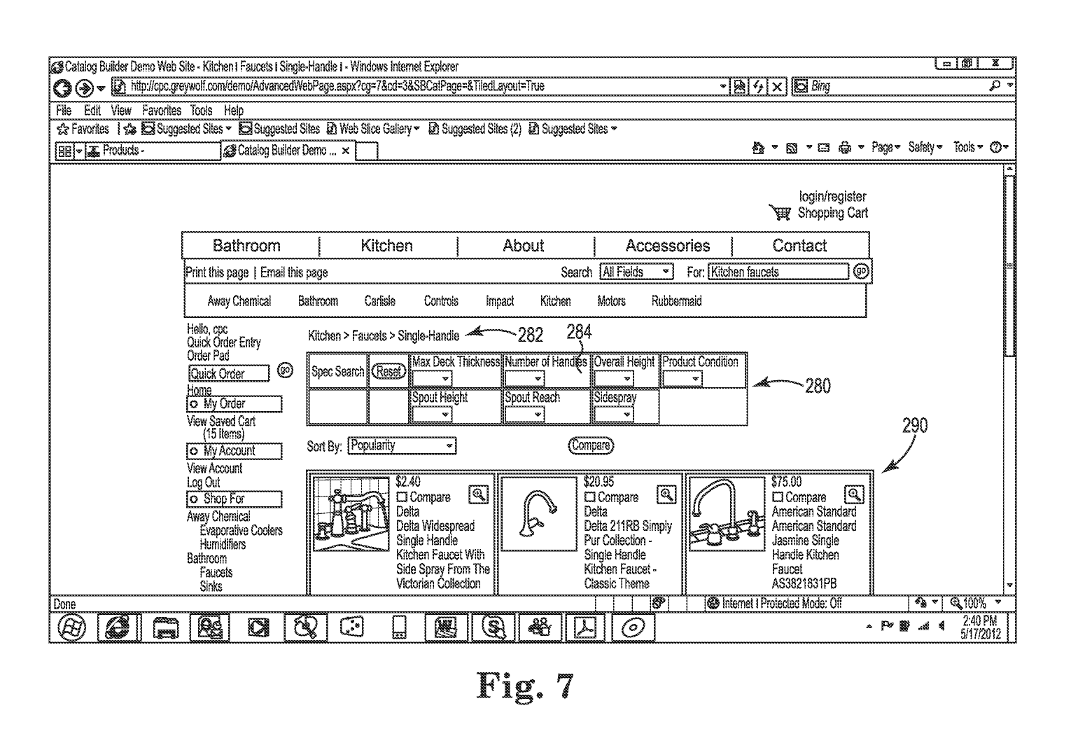

Referring now to FIG. 7, an alternative format for the web page presentation is shown. As illustrated, a portion of the display will list products based on certain attributes. For example, a first level of product attributes will be listed, with subcategories configured thereunder. This information will be pulled directly from the database, and will include all different specific attributes sharing a certain higher level category or higher level attribute. This information can then be selected and shown on the display in a grid or selection box format. For example, selection box format 280 is illustrated in a central portion of the display. A grid presentation 290 can also be presented, which is also shown below. An category or attribute listing 282 illustrates the specific features involved. In this example, the selected category of attributes include “kitchen/faucets/single handle.” The selection box display 280 will then automatically present all various additional attributes available within this selected product category. As illustrated, selection box 280 includes various specifications which can be searched to provide further specificity to the user. Although not illustrated, the drop down menus contained in each box will include each specific subcategory found within the database corresponding to that feature. For example, continuing with the “kitchen faucets” concept, box 284 includes the ability to select the number of handles included. Based upon the information within the database, a pull down listing will allow a user to select every particular option available in the number of handles category.

Depending upon the selections made by the user, the matrix format then illustrates the various specific products corresponding to the selected values. The matrix listing 290 can include many types of information, including photographs, illustrations, features, etc. In this manner, an attractive information presentation is made, providing images and other useful information for the particular users. As will be appreciated, all of these features and this format of information presentation is based upon the system's determination of the various attributes available and presentation of those attributes, based upon the information contained in the database itself.

V. Photo Handling

In a further effort to provide an effective system, the photo-handling methodology of the present system also provides additional efficiency. Generally speaking, three sizes of images are typically utilized in electronic media, including a thumbnail, an icon, and a typical picture size image. To avoid the need to manage all three image sizes, image file management system 56 help coordinates the appropriate creation of these three image sizes utilizing only a single image file. In this manner, the database structure is effectively utilized, while appropriate images are also presented during product presentations. To accomplish this, the image file management system 56 will recreate the appropriate sized image for the particular application automatically. Thus operator doesn't have to convert and store the images manually in multiple sizes, and only one image file is needed.

VI. Search Filtering Features

When undertaking search activities, the relevant search results are determined by the present system and method using trigger keywords, exact-match search terms, partial match search terms, the position of the search term with a partial match, synonym terms (“1” or “one”), and matches based on reordering the aforementioned relevance points. Website users then have the option to filter the relevant search results by user-defined—but dynamically generated—filters, by category, by data fields, or by specification. To further provide efficient filtering, a synonym handling technique can also be applied which can easily recognize related words and concepts.

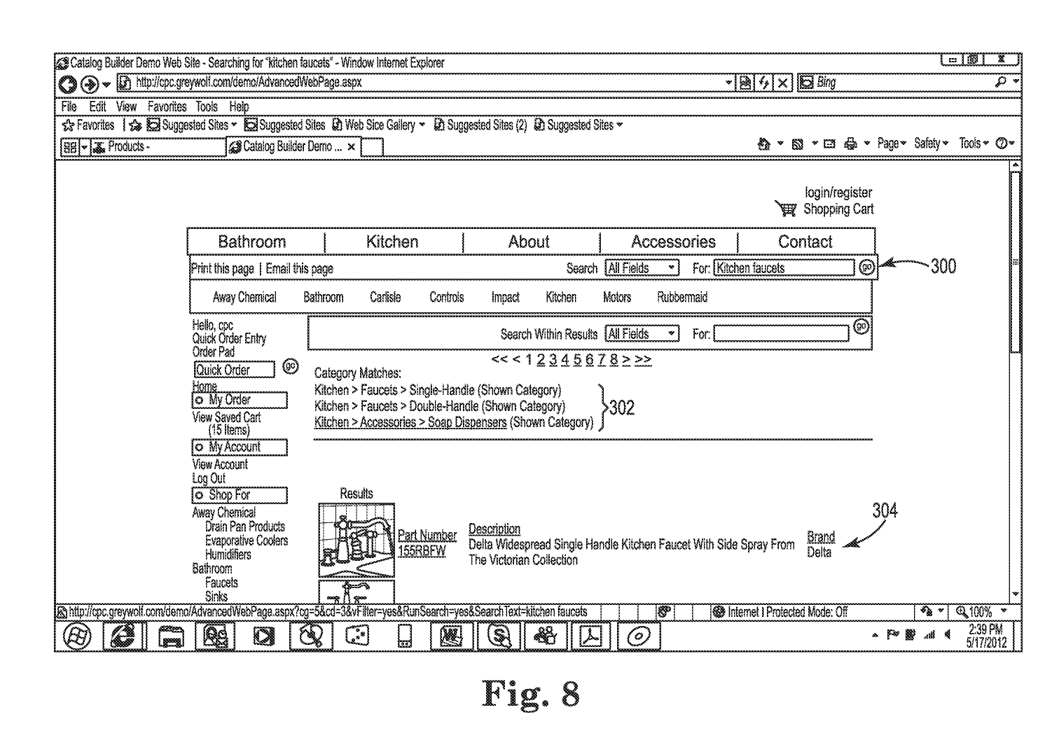

The system further provides several search options for users. These options include global searching, category searching or searching based upon other attributes. As contemplated, the results will be filtered based upon the particular level involved. In each case, the searching and filtering of results will be automated based upon the database operation, and will produce various results. Referring to FIG. 8, the results of one particular filtering operation are illustrated. As shown in search box 300, the user is provided with the ability to search within a particular category. The search options themselves are then provided by the present system based upon information contained within the database. In this example, kitchen faucets has been selected. This selection is based upon a particular attribute identified in the database as being appropriate for the necessary searching (i.e. kitchen faucets). In this illustration, the category matching presentation 302 is also illustrated. Here, the system has identified the various categories which fall underneath the “kitchen faucets” search, thus provided these selection options for users. As will be clearly appreciated, these category matching presentation is dictated by the information in the database, and automatically presented as a search or filtering option. Although these options are present, the various products are also displayed by the system in a product presentation format, shown in section 304. Here, various details regarding the specific product are easily illustrated.

The search engine utilized by the system is a filtered, self-generating, item and specification search built on a unique relevance algorithm. Using this search engine, results are up to date and appropriate, thus providing more efficient usability. The searchable information is generated real-time from the user-created catalog data. Consequently, there is no need for a user to build the searchable indexes. The user simply flags the database fields to search and the software does the rest automatically. The search algorithm eliminates irrelevant records based on the search terms and data, not on a manually created index.

The specification search is also generated dynamically instead of by manual index creation. Once the user chooses which fields are eligible for inclusion in the specification search, the search algorithm will determine which fields are appropriate for a given group of items. Again, the above mentioned relevance algorithm is helpful here. Fields with no data will not be displayed for the website user, giving a clean, easy-to-use interface with very little setup time.

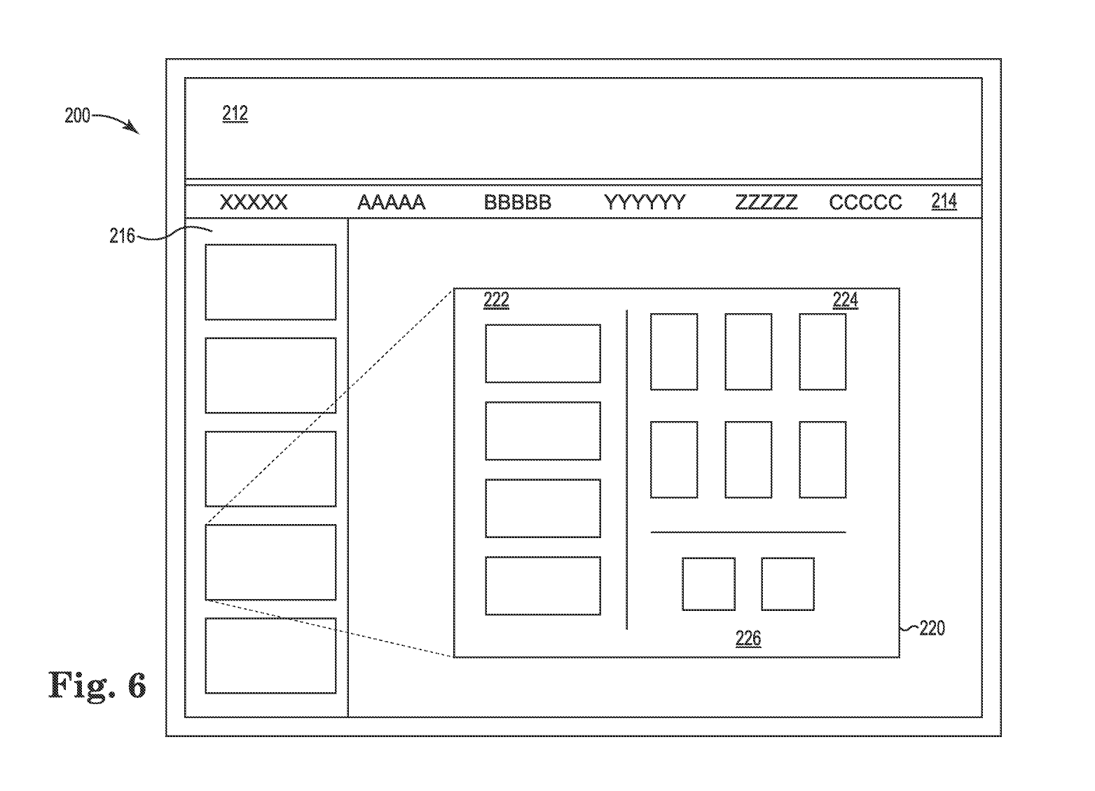

In certain embodiments, all of the above processes and subsystems are generally utilized to create web page presentations of information. FIG. 6 is an illustration of another general web page which is dynamically created utilizing the present system and method. As shown here, web page 200 includes a header section 212 which is generally adapted for the presentation of general information. For example, the company name or supplier information would most advantageously be presented here. In addition, web page 200 includes a top bar 214. The generation of top bar 214 is discussed in further detail above in relation to FIGS. 4 and 5.

In a similar matter, a category section generator 216 is listed. This category generation, generally speaking, relates to the subcategories previously discussed. For each subcategory (or submenu), an icon is created or some type of indicator is provided in category section 216. Although this section is illustrated as a column down one particular side of the web page 200, many different configurations are possible. For example, this information could occupy the entire screen, subsections of the display, etc. Again, the information contained within the category section is dictated by the detailed data contained in the database. The system recognizes various data types and categories and thus dynamically creates the various selections provided.

As contemplated, the information in category section 216 provides users with the ability to further designate and identify details related to particular information. As illustrated in FIG. 6, the selection of one box or icon within category section 216 generates a further pop-up, presenting additional details and information. In this detail box 220, further detailed subcategories and options can be presented. For example, a first area 222 may include color options for a particular product, a second area 224 may include operating features or characteristics for the product categories, whereas a third area 226 may include dimensional characteristics. Again, each of these subcategories or sub-subcategories are dictated by information provided in the database itself related to the relevant products. The system recognizes these database variations and generates the appropriate displays.

VII. Content Groups

In certain circumstances, it is necessary for an organization to limit the product offerings or information provided based on several different factors. For example, a distributor may carry multiple brands, however may have different territory limitations for each brand. In these situations, it is beneficial to modify catalogs, customize printed materials, or edit a website based upon these limitations. Generally speaking, these abilities are achieved utilizing content groups “indicators” in the database. As one example, the content groups may include various brands for the multiple products contained in the database. Alternatively, the content groups may designate a number of subsidiaries for related companies that are all managed and coordinated by one parent. As a further example, the content groups may designate certain distributors utilized by the particular organization. As yet another example, the content groups may designate territories or regions in which a certain product or set of products is exclusively sold. When it is necessary to prepare printed materials, or build an appropriate website, these content groups can thus be utilized to provide the appropriate and necessary limitations.

Using the content groups discussed above, product information for only the designated grouping can be easily achieved. This grouping may occur in the website building process, by setting a particular flag to utilize only designated content groups. Thus, the website and all related searching activity will be limited to a smaller and more reasonable subset of information. This provides additional efficiency to the website itself during both the build and search processes. That said, the database itself is maintained in the same overall format (i.e. subdatabases are not created). In this manner, the organization is continuing to operate from one consistent and complete database. This provides certain features, such as the ease and efficiency of updates to only the one database, without requiring multiple steps. In addition, the content groups and all related features are maintained at the database level, and grouping activities occurs on the back-end of the process, thus providing additional efficiency.

The above description provides several embodiments and configurations for the presentation of information and the dynamic generation of product information presentations. It is understood that the specific embodiments described are examples, and many variations are possible, all coming within the scope and spirit of the following claims. The invention is not intended to be limited to these specific embodiments, however, to encompass all variations utilizing the concepts described above.

What is claimed is:

1. A database driven method for dynamically generating a customizable presentation of multiple products, wherein the database includes a plurality of product attributes related to the products and each product has a set of specifications including at least one attribute, comprising:
designating a first set of attributes from the database to be used as a first level of product categories;
designating a second set of attributes from the database to be used as a second level of product categories, wherein each of the second attributes is a subset of the first set of attributes; and
developing a presentation output which allows a user to examine a set of overall specifications, wherein the output presentation includes a selected output format.

2. The method of claim 1 wherein the output presentation is a printed catalog having a listing of product specifications for each product having an attribute in the first set of attributes and in the second set of attributes.

3. The method of claim 1 wherein the output presentation comprises the building of a website, with the website using the first set of attributes as a first selection option, and wherein the second set of attributes provides a second level of selection based upon the first selection option provided, and wherein a user selection of one of the second set of attributes produces further product selection options.

4. The method of claim 3 wherein the first selection option is a displayed menu and the second selection option is a drop-down menu selected from the displayed menu.

5. The method of claim 4 wherein the designation as a first selection option and the designation of a second selection option is stored within the database.

6. The method of claim 5 wherein selection of an item from the drop-down menu causes presentation of products having attributes corresponding to the second selection option.

7. The method of claim 1 wherein the output presentation comprises a user selected set of attributes, selected from the first level and second level of product categories and wherein the output presentation is limited to products within the user selection.

8. The method of claim 7 wherein the output presentation is a printed catalog having a listing of product specifications for each product meeting the user selected first level and second level of product categories.

9. The method of claim 7 wherein output presentation comprises the building of a website, with the website using the first set of attributes as a first selection option, and wherein the second set of attributes provides a second level of selection based upon the first selection option provided, and wherein a user selection of one of the second set of attributes produces further product selection options.

10. The method of claim 1 wherein the first set of attributes are designated by identifying a content group identifier, and the first level product category includes only products falling within the content group.

11. The method of claim 10 wherein the output presentation comprises the building of a website, with the website using the second set of attributes provides a selection option based upon the second set of attributes within the database.

12. A database driven method for dynamically generating a customized presentation of multiple products, wherein the database includes a plurality of product attributes related to the products and each product has a set of specifications designating an image contained within a single corresponding image file, comprising:
selecting the multiple products for inclusion in the customized presentation from within the a product database, including a selection of the single image file for each selected product;
determining an optimum image characteristic to be used for the presentation of the image in the customized presentation; and
building the customized presentation, wherein, if the single image file does not match the optimum image characteristics, the image file is converted to a format matching the optimum image characteristics, and if the image file matches the optimum characteristics, the image file is used without conversion.

13. The database driven method of claim 12 wherein the optimum image characteristic is an image having a first size, a second size or a third image size, and the conversion process involves resizing the image when necessary.

14. The database driven method of claim 12 wherein the optimum image characteristic is an image having a first resolution, and the conversion involves converting the image from a second resolution to the first resolution.

15. The database driven method of claim 12 wherein the database maintains a designation of the location of the single corresponding image file, and the step of building the customized presentation comprises retrieval of the image file from the designated location.

16. A database driven method for dynamically generating a customized presentation of multiple products, wherein the database includes a plurality of product attributes related to the products and each product has a set of specifications including multiple attributes, comprising:
selecting at least one product attribute and determining the multiple products for inclusion in the customized presentation based upon the selected at least one attribute, wherein the multiple products comprise those products from within the a product database having the select attribute;
determining the format of the set of specifications for the selected multiple products stored within the database; and
building the customized presentation, wherein specifications are automatically converted to the optimum format for a presentation output.

17. Thedatabase driven method of claim 16 wherein the presentation output is a website, and the conversion involves the conversion of a specification stored in a text format to a specification produced in HTML format

18. A database driven method for dynamically generating a customized presentation of multiple products, wherein the database includes a plurality of product attributes related to the products and each product has a set of specifications including multiple attributes, comprising:
building a product presentation which allows a user to select at least a first product attribute, wherein a resulting group of products within the database will include the selected attribute;
dynamically filtering the attributes related to the resulting group of products and generating a selection presentation including a set of selection options, wherein each of the selection options includes one of the attributes related to the resulting group of products; and
presenting the selection presentation to a user thus allowing the user to select a chosen option from the selection options, and generate a customized product presentation which includes a set of products which each have the selected attribute and the chose option.

19. The method of claim 18 wherein the selection presentation comprises a category listing, wherein the category listing presents a list of a plurality of categories of additional attributes which are attributes of the resulting group of products and the selection of one of the category listings will result in the product presentation that includes products having both the first attribute and the additional attribute.

20. The method of claim 19 wherein the selection presentation comprises a category listing, wherein the category listing comprises a presentation of additional categories of attributes which are attributes of the resulting group of products, wherein the categories are further presented with drop-down menu options, allowing the user to select a category attributes in falling within the identified category.

21. A database driven method for dynamically generating a customized presentation of multiple products, wherein the database includes a plurality of product attributes related to the products and each product has a set of specifications including multiple attributes, comprising:
identifying at least one field within the database which is searchable;
designating at least one selected attribute;
dynamically filtering the database to identify a resulting group of products within the database will include the at least one selected attribute wherein filtering uses a database values to identify the resulting groups;
building the customized presentation using the resulting group of products, wherein the customized presentation.
